(19) United States
(12) Patent Application Publication
(10) Pub. No.: US 2026/0327410 A1
(43) Pub. Date: Oct. 22, 2026

(54) BIOPOLYMER AND MATERIAL COMPOSITE CONTAINMENTS

(71) Applicant: Double Double D, LLC, Burlington, KY (US)

(72) Inventors: Daniel G. DOSTER, Waynesville, OH (US); Michael A. DeBROSSE, Dayton, OH (US)

(21) Appl. No.: 19/113,212

(22) PCT Filed: Sep. 22, 2023
(86) PCT No.: PCT/US2023/074907

§ 371 Date: Mar. 19, 2025

Related U.S. Application Data
(60) Provisional application No. 63/409,541, filed on Sep. 23, 2022.

(51) Int. Cl. C08L 1/02; B32B 23/06; B32B 23/20; B32B 27/10; B32B 27/28; B32B 27/30; B32B 27/36; C08B 1/00; C08B 30/00; C08F 114/06; C08F 116/06; C08G 63/06; C08K 3/36; C08K 5/07; C08K 11/00

(52) U.S. Cl. CPC C08L 1/02; B32B 23/06; B32B 23/20; B32B 27/10; B32B 27/288; B32B 27/302; B32B 27/306; B32B 27/36; C08B 1/00; C08B 30/00; C08F 114/06; C08F 116/06; C08G 63/06; C08K 3/36; C08K 5/07; C08K 11/00; B32B 2250/02; B32B 2307/7163; B32B 2439/60

(57) ABSTRACT

The present disclosure concerns containments that are biodegradable. In some aspects, the containments include at least one biopolymer layer that includes one or more polymeric compounds. In some aspects, the containments include at least one material layer that includes one or more composites. In some aspects, the biopolymer layer is of a composite of one or more polymeric compounds and at least one material. In some aspects, the containment is an assembled collection of at least two parts. In some aspects, the biopolymer layers of each part of fused by heat sealing.

### CROSS-REFERENCE TO RELATED APPLICATIONS

This application claims priority to U.S. Provisional Patent Application 63/409,541, filed Sep. 23, 2022, the content of which is hereby incorporated by reference in its entirety.

### BACKGROUND

Plastic bottles and plastic containers in general are popular due to the convenience and disposability, yet they consume landfill space at an alarming rate, requiring years to degrade if at all. Many plastics are not recyclable or they are not properly recycled, never reaching a recycling center. The capability to degrade naturally offers a solution that removes responsibility from a consumer and alleviates landfill space. Business that deal in disposable packaging, such as beverages, would find it advantageous to use ecologically safe containments not only because of the ecological benefits in reusing materials, but because it would reinforce their public esteem. As such, a need exists in the industry for improved features for an ecologically safe containment.

### SUMMARY

A 1^{st} aspect of the present disclosure, either alone or in combination with any other aspect herein concerns a containment comprised of a biopolymer layer comprised of a biopolymer, wherein the biopolymer includes at least one of polyhydroxyalkanote (PHA), poly(hydroxybutyrate-co-hydroxy valerate (PHBV), polybutylene succinate (PBS), lignin, starch, polyhydroxybutyrate (PHB), PHBH (random copolymer of (R)-3-hydroxybutyrate and (R)-3-hydroxyhexanoate), polylactic acid (PLA), polybutylene adipate terephthalate (PBAT), PBST (polybutylene succinate-co-terephthalate), PBSA (polybutylene succinate-co-butylene adipate), polybutylene terephthalate (PBT), poly(vinyl) alcohol (PVA), poly(glycolic acid) (PGA), chitosan, polycaprolactone (PCL), and combinations thereof.

A 2^{nd} aspect of the present disclosure, either alone or in combination with any other aspect herein concerns the containment of the 1^{st} aspect, wherein the biopolymer is a composite of one or more polymeric compounds and a material.

A 3^{rd} aspect of the present disclosure, either alone or in combination with any other aspect herein concerns the containment of the 2^{nd} aspect, wherein in the material comprises at least one of silica nanoparticles, hydrophobic silica nanoparticles, bees wax, soya wax, cellulose, cellulose acetate, cellulose triacetate, carboxy methyl cellulose, alkyl ketene dimer (AKD), AKD nanoparticles, AKD wax, poly(vinyl) alcohol (PVA), palmityl chloride, polyvinyl palmitate chloride (PVPC), starch (soluble), starch nanoparticles, xylan, tapioca, palm root, tetraethyl orthosilicate (TEOS), zein, zein nanoparticles, glycerol, gelatin, sorbitol, ammonium zirconium carbonate (AZC), ethylene-vinyl alcohol copolymer (EVOH), polyhydroxy alkanotes (PHA), polydimethylsiloxane (PDMS), gelatin, sodium acetate, lignin, zinc oxide nanoparticles, copper (II) oxide nanoparticles, copper (I) oxide nanoparticles, magnesium oxide nanoparticles, nano clay nanoparticles, nano-starch nanoparticles, beeswax nanoparticles, soy wax nanoparticles, nano-cellulose nanoparticles, carbon nanotubes nanoparticles, carbon nanotube fiber nanoparticles, stearic acid, glycerol, starch, HNTs, PDMS, soybean oil, zein, chitosan, nano clay, cellulose nanofibers, cellulose ester(s), PLA, and/or PCL and/or titanium dioxide nanoparticles.

A 4^{th} aspect of the present disclosure, either alone or in combination with any other aspect herein concerns the containment of any of the 1^{st} through 3^{rd} aspects, wherein the biopolymer layer is heat sealed.

A 5^{th} aspect of the present disclosure, either alone or in combination with any other aspect herein concerns the containment of any of the 1^{st} through 4^{th} aspects, further comprising a material layer.

A 6^{th} aspect of the present disclosure, either alone or in combination with any other aspect herein concerns the containment of the 5^{th} aspect, wherein the material layer comprises a composite of at least two of a binding agent, an active agent, a structural agent, a plasticizer, and a gelatinizer.

A 7^{th} aspect of the present disclosure, either alone or in combination with any other aspect herein concerns the containment of the 6^{th} aspect, wherein the binding agent is selected from natural waxes, bees wax, soya wax, alkyl ketone dimer (AKD), starch (e.g. maize starch, yam starch, corn starch, palm starch, and cassava starch), ethylene vinyl alcohol (EVOH), polydimethylsiloxane (PDMS), gelatin, tapioca, palm root, cellulose, carboy methyl cellulose, and combinations thereof.

An 8^{th} aspect of the present disclosure, either alone or in combination with any other aspect herein concerns the containment of the 7^{th} aspect, wherein the active agent is selected from gelatin, polyvinyl alcohol (PVA), starch (e.g. yam starch, palm starch (or palm sago starch), cassava starch, maize starch, and corn starch), AKD nanoparticles, silica nanoparticles, hydrophobic silica nanoparticles, EVOH, zein nanoparticles, cellulose, starch nanoparticles, agar, carboxy methyl cellulose, lignin, and combinations thereof.

A 9^{th} aspect of the present disclosure, either alone or in combination with any other aspect herein concerns the containment of the 7^{th} aspect, wherein the structural agent is selected from cellulose acetate, cellulose triaceteate, palmityl chloride, sodium acetate, or combinations thereof.

A 10^{th} aspect of the present disclosure, either alone or in combination with any other aspect herein concerns the containment of the 7^{th} aspect, wherein the plasticizer is selected from glycerol, xylene, sorbitol, glycerol and sorbitol, and combinations thereof.

An 11^{th} aspect of the present disclosure, either alone or in combination with any other aspect herein concerns the containment of the 7^{th} aspect, wherein the gelatinizer is selected from starch; gelatin; starch and gelatin, TEOS, agar, PVA, PVA and gelatin, polydimethylsiloxane (PDMS), EVOH, stearic acid, polyvinyl palmitate chloride, polyhydroxy alkanotes (PHA), PVA, PVPC, PVA and PVPC, cellulose, ammonium zirconium carbonate (AZC), and combinations thereof.

A 12^{th} aspect of the present disclosure, either alone or in combination with any other aspect herein concerns the containment of any of the 1^{st} through 11^{th} aspects, further comprising a pulp layer.

A 13^{th} aspect of the present disclosure, either alone or in combination with any other aspect herein concerns a containment comprised of a material comprised of a composite of at least two of a binding agent, an active agent, a structural agent, a gelatinizer, and a plasticizer.

A 14^{th} aspect of the present disclosure, either alone or in combination with any other aspect herein concerns the containment of the 13^{th} aspect, wherein the binding agent is selected from natural waxes, bees wax, soya wax, alkyl ketone dimer (AKD), starch (e.g. maize starch, yam starch, corn starch, palm starch, and cassava starch), ethylene vinyl alcohol (EVOH), polydimethylsiloxane (PDMS), gelatin, cellulose, tapioca, palm root, carboy methyl cellulose, and combinations thereof.

A 15^{th} aspect of the present disclosure, either alone or in combination with any other aspect herein concerns the containment of the 13^{th} aspect, wherein the active agent is selected from gelatin, polyvinyl alcohol (PVA), starch (e.g. yam starch, palm starch (or palm sago starch), cassava starch, maize starch, and corn starch), AKD nanoparticles, silica nanoparticles, hydrophobic silica nanoparticles, EVOH, zein nanoparticles, cellulose, starch nanoparticles, agar, carboxy methyl cellulose, lignin, and combinations thereof.

A 16^{th} aspect of the present disclosure, either alone or in combination with any other aspect herein concerns the containment of the 13^{th} aspect, wherein the structural agent is selected from cellulose acetate, cellulose triaceteate, palmityl chloride, sodium acetate, or combinations thereof.

A 17^{th} aspect of the present disclosure, either alone or in combination with any other aspect herein concerns the containment of the 13^{th} aspect, wherein the plasticizer is selected from glycerol, xylene, sorbitol, glycerol and sorbitol, and combinations thereof.

An 18^{th} aspect of the present disclosure, either alone or in combination with any other aspect herein concerns the containment of the 13^{th} aspect, wherein the gelatinizer is selected from starch; gelatin; starch and gelatin; agar; PVA, TEOS, PVA and gelatin, polydimethylsiloxane (PDMS), EVOH, stearic acid, polyvinyl palmitate chloride, polyhydroxy alkanotes (PHA), PVA, PVPC, PVA and PVPC, cellulose, ammonium zirconium carbonate (AZC), and combinations thereof.

A 19^{th} aspect of the present disclosure, either alone or in combination with any other aspect herein concerns the containment of the 13^{th} aspect, wherein the material composite comprises at least three of the binding agent, the active agent, the structural agent, the gelatinizer, and the plasticizer.

A 20^{th} aspect of the present disclosure, either alone or in combination with any other aspect herein concerns the containment of any of the 13^{th} or 19^{th} aspects, wherein the material composite comprises at least four of the binding agent, the active agent, the structural agent, the gelatinizer, and the plasticizer.

A 21^{st} aspect of the present disclosure, either alone or in combination with any other aspect herein concerns the containment of any of the 13^{th}, 19^{th}, or 20^{th} aspects, wherein the material composite comprises at the binding agent, the active agent, the structural agent, the gelatinizer, and the plasticizer.

A 22^{nd} aspect of the present disclosure, either alone or in combination with any other aspect herein concerns the containment of any of the 13^{th} through 21^{st} aspects, further comprising a biopolymer, wherein the biopolymer includes at least one of polyhydroxyalkanote (PHA), poly(hydroxybutyrate-co-hydroxy valerate (PHBV), polybutylene succinate (PBS), lignin, starch, polyhydroxybutyrate (PHB), PHBH (random copolymer of (R)-3-hydroxybutyrate and (R)-3-hydroxyhexanoate), polylactic acid (PLA), polybutylene adipate terephthalate (PBAT), PBST (polybutylene succinate-co-terephthalate), PBSA (polybutylene succinate-co-butylene adipate), polybutylene terephthalate (PBT), poly(vinyl) alcohol (PVA), poly(glycolic acid) (PGA), chitosan, polycaprolactone (PCL), and combinations thereof.

A 23^{rd} aspect of the present disclosure, either alone or in combination with any other aspect herein concerns the containment of any of the 13^{th} through 22^{nd} aspects, further comprising a layer of pulp.

### DESCRIPTION

The present disclosure concerns biodegradable containments, wherein each component and/or material will degrade over time. In some aspects, the containment may contain at least one of a pulp, a biopolymer, or a material. In some aspects, the containment may include layers of each individual material, such as a pulp layer, a biopolymer layer, and a material layer or of a pulp layer and a biopolymer layer, or of a pulp layer and a material layer, or of a biopolymer layer and a material layer. In some aspects, the containment includes a layer of a single material, a containment of two layers of two materials, or a containment of three layers including all three materials. In further aspects, each material may be layered multiple times, including two, three, four, five or more. In some aspects, the materials may be layered on the same material, and in other aspects, the materials may be layered onto a different material. In some aspects, a layer may be a composite of a pulp material and/or a biopolymer material and/or a material.

In some aspects, the containment may be of a pulp, a biopolymer, and a material layer. In some aspects, the containment may be of a pulp and a biopolymer. In some aspects, the containment may be of a pulp and a material. In some aspects, the containment may be of a biopolymer and a material. In some aspects, the containment may be of a pulp, a biopolymer, and/or a material layer.

### Pulp

In some aspects, the containment includes a pulp material. The pulp may be provided as a layer, such as an external layer, an internal layer, and/or an intermediate layer. Pulp refers to biomass obtained from one or more plants, including trees, grasses, bamboo, hemp, fruits, nuts, leaves, bark, wood, sugar cane, stems, husks, roots, and the like. In some aspects, the pulp material may be created from any vegetation or vegetation-based products, such as wood by-products (including paper), bamboo, hard woods, soft woods, hemp, husks, rinds, minerals, agricultural waste, agricultural products, agricultural by-products, recycled materials, or a mixture of two or more thereof. Pulp may include recycled materials, such as paper and/or cardboard. Pulp can be formed from the mixing of one or more vegetation derived biomasses in a solution or solvent to provide a malleable mass. Pulp may include cellulose and/or lignin, such a lignocellulosic fibrous material. In some aspects, the pulp may be chemically treated and/or physically mixed to homogenize the varying source materials that may be included in the pulp. The pulp may result from treatment of a lignocellulosic material through the Kraft process, a sulfite process, soda pulping, treatment with sodium carbonate, sodium hydroxide treatment, sodium sulfate treatment, mechanical grinding, enzyme treatment, steam treatment solvent treatment (e.g. methanol, ethanol, formic acid, and/or acetic acid treatment), and combinations thereof. In some aspects, pulp may include a mixture of cellulose and/or lignins. In some aspects, the source materials may be selected to provide certain compounds within the pulp that provide additional strength and/or additional malleability to the contained.

### Material Layer

In some aspects, the containments of the present disclosure includes a material layer which may include one or more composites, nanomaterials and/or nanoparticles (NPs). In some aspects, the nanomaterial is provided as a nanoparticle. It will be appreciated that a nanoparticle can be of about 1 to about 100 nm in diameter or cross-sectional width, including about 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, and 99 nm. With regard to the nanomaterials, it will be appreciated that the dimensions of such may vary depending on the material at issue, taking into account the shape and composition, as well as a discernable size. It will also be appreciated that a nanomaterial may present a material with a size on a nanoscale.

The material layer may be provided in the containment as a layer, such as an external layer, an internal layer, and/or an intermediate layer. The material layer may include nanoparticles, such as nanoparticles suspended or dispersed throughout the material layer. A material layer may be formed with any other layer as described herein. For example, a material layer may be made concurrently with a biopolymer layer as a single combined layer to then be layer with a pulp layer and vice versa.

The materials or components of the material layer may be of a hydrophobic material, a hydrophilic material, or a combination thereof. In some aspects, the materials may include a composite or nanocomposite to two or more materials. The components may include a composite of two or more of: silicon dioxide (silica) nanoparticles (NPs), zinc oxide NPs, copper oxide (including copper (II) oxide (cupric oxide or CuO) and/or copper (I) oxide (Cu₂O)), magnesium oxide, nano clay, nano-starch, wax, beeswax, soya wax, nano-cellulose, cellulose acetate, cellulose, caroxy methyl cellulose, hydrophobic silica (or superhydrophobic silica), polydimethylsiloxane, alkyl ketene dimer (AKD), AKD wax, AKD NPs, polyvinyl alcohol (PVA), polyvinyl palmitate chloride (PVPC), polydimethylsiloxane (PDMS), starch (e.g. corn starch, cassava starch, yam starch, palm sago starch, palm root), soluble starch, starch nanoparticles, ammonium zirconium carbonate (AZC), lignin, glycerol, tapioca, tetraethyl orthosilicate (TEOS), gelatin, xylan, polyhydroxy alkanotes (PHA), ethylene-vinyl alcohol copolymer (EVOH), zein, zein NPs, sorbitol, sodium acetate, chloroform, sorbitol, carbon nanotubes and/or carbon nanotube fibers, and/or titanium dioxide. In some aspects, the material composite may further include a biopolymer, such as polyhydroxyalkanote (PHA), poly(hydroxybutyrate-co-hydroxy valerate (PHBV), polybutylene succinate (PBS), lignin, starch, polyhydroxybutyrate (PHB), PHBH (random copolymer of (R)-3-hydroxybutyrate and (R)-3-hydroxyhexanoate), polylactic acid (PLA), polybutylene adipate terephthalate (PBAT), PBST (polybutylene succinate-co-terephthalate), PBSA (polybutylene succinate-co-butylene adipate), polybutylene terephthalate (PBT), poly(vinyl) alcohol (PVA), poly(glycolic acid) (PGA), chitosan, polycaprolactone (PCL), and combinations thereof.

In some aspects, the composite or a material thereof may be treated or pre-treated to change the hydrophobic nature thereof, such as from a hydrophobic material to a hydrophilic material or vice versa. In some aspects, the materials can include a pre-cursor liquid or gel form that allows for application as a spray or into a mold, wherein it becomes a solid layer or part of the containment through the removal of one or more solvents therein. In some aspects, the material can be sprayed into a mold and dried there in to provide the material layer or applied to a mold and allowed to solidify therein. In some aspects, the material may be used by itself for the containment, as in the containment or the body thereof is entirely of the material and/or composites thereof. In some aspects, the material may be coupled with the pulp material. In some aspects, the material may be coupled with a biopolymer as set forth herein. In some aspects, the material may be used in combination with a biopolymer and the pulp material.

In some aspects, two or more materials are combined into a composite or nanocomposite. It will be appreciated that the two can be used interchangeably, with nanocomposite referring to a composite of two or more materials as set forth herein. It will be appreciated that a composite or nanocomposite further not be limited to the materials set forth herein. For example, a nanocomposite may be prepared in an aqueous solution or an organic solvent for the purposes of application to preparing the containments as set forth herein. In some aspects, the composite may include water. Such will be understood to include distilled, R.O. (reverse osmosis), or other purified waters.

In some aspects, the material is a composite of two or more of the materials as set forth herein. In some aspects, the composite is formed by homogenizing the two materials or compounds in a single solution and using the resulting composite in a spray or mold to form the containment or to become a part or layer thereof. In some aspects, the material is formed from a homogenous solution. In other aspects, one or more materials may be suspended within a solution that is then formed into the containment or adapted therein as a layer or part thereof. In some aspects, the composite may include both suspended and dissolved materials in a single solution that is sprayed or molded into a layer, a container, or a part thereof. For example, as set forth herein, the composite in some aspects includes one or more nanoparticles. In some aspects, the nanoparticles remain a solid during the formulation of the composite, resulting in even distribution throughout the final material. In some aspects, the composites or composites may be formulated through a single homogenization or mixing process, or may be formulated in two or more steps, such as with adding a third material once a first and a second thereof are already mixed or homogenized. It will be apparent that the composite can be of combining the materials all at once, individually, or in combinations to achieve the final composite material.

In aspects, the composites of the present disclosure may include at least two of a binder, an active material, a structural material, a gelatinizer, and/or a plasticizer. In some aspects, a particular material may provide multi-functionality, such as acting as an active material and a binder.

In some aspects, the binder or binding agent is provided to hold the components of the composite or composite together. Examples of such materials include: natural waxes, bees wax, soya wax, alkyl ketone dimer (AKD), starch (e.g. maize starch, yam starch, corn starch, palm starch, and cassava starch), ethylene vinyl alcohol (EVOH), polydimethylsiloxane (PDMS), gelatin, cellulose, and carboy methyl cellulose.

In some aspects, the active agent may include a compound that provides an active feature to the containment, such as hydrophobicity or a barrier to prevent water vapor and/or oxygen transmission across the material or the layer of material. Examples of such include: gelatin, polyvinyl alcohol (PVA), starch (e.g. yam starch, palm starch (or palm sago starch), cassava starch, maize starch, and corn starch), AKD nanoparticles, silica nanoparticles, hydrophobic silica nanoparticles, EVOH, zein nanoparticles, cellulose, starch nanoparticles, agar, carboxy methyl cellulose, lignin, and combinations thereof. In some aspects, two or more materials may cooperatively provide the active material, such as starch and PVA; starch, gelatin, and PVA; gelatin and PVA; starch and lignin; starch and gelatin; starch and carboxy methyl cellulose; starch and cellulose; starch nanoparticles and silica nanoparticles; AKD nanoparticles and silica nanoparticles; EVOH and AKD nanoparticles; EVOH and silica nanoparticles, EVOH, silica nanoparticles, and AKD nanoparticles; and, EVOH and zein nanoparticles.

In some aspects, the structural agent provides support for structural integrity and to assist in maintaining the shape and size of the containment. Examples include: cellulose acetate, cellulose triaceteate, palmityl chloride, sodium acetate, or combinations thereof.

In some aspects, the composite may include a gelatization agent or gelatinizer to allow the composite to form as a gel to allow for application or formation of the containment or a layer or part therein, such as through molding and/or spraying. Examples include: starch; gelatin; starch and gelatin; agar; PVA; PVA and gelatin; polydimethylsiloxane (PDMS); EVOH; stearic acid; polyvinyl palmitate chloride; polyhydroxy alkanotes (PHA); PVA; PVPC; PVA and PVPC; cellulose; ammonium zirconium carbonate (AZC); and combinations thereof.

In some aspects, the composite may include a plasticizer to add to the pliability, flexibility, and/or feel of the composite. Examples include: glycerol, xylene, sorbitol, glycerol and sorbitol, and combinations thereof.

In some aspects, the composite includes: a binding agent and an active agent; a binding agent and a structural agent; a binding agent and a gelatinization agent; a binding agent and a plasticizer; an active agent and a structural agent; an active agent and a gelatinizer; an active agent and a plasticizer; a structural agent and a gelatinizer; a structural agent and a plasticizer; a binding agent, active agent, and structural agent; a binding agent, active agent and gelatinizer; a binding agent, active agent and plasticizer; a binding agent, structural agent, and gelatinizer; a binding agent, structural agent, and plasticizer; a binding agent, gelatinizer, and plasticizer, an active agent, structural agent, and gelatinizer; an active agent, structural agent, and plasticizer, an active agent, gelatinizer, and plasticizer; a structural agent, gelatinizer, and plasticizer; a binding agent active agent, structural agent, and gelatinizer; a binding agent, active agent, structural agent, and plasticizer; a binding agent, structural agent, gelatinizer, and plasticizer; an active agent, structural agent, plasticizer, and gelatinizer; a binding agent, active agent, structural agent, gelatinizer, and plasticizer; or combinations thereof.

In some aspects a composite may include two or more components selected from silica nanoparticles, hydrophobic silica nanoparticles, bees wax, soya wax, cellulose, cellulose acetate, cellulose triacetate, carboxy methyl cellulose, alkyl ketene dimer (AKD), AKD nanoparticles, AKD wax, poly(vinyl) alcohol (PVA), palmityl chloride, polyvinyl palmitate chloride (PVPC), starch (soluble), starch nanoparticles, xylan, zein, zein nanoparticles, glycerol, gelatin, sorbitol, ammonium zirconium carbonate (AZC), ethylene-vinyl alcohol copolymer (EVOH), polyhydroxy alkanotes (PHA), polydimethylsiloxane (PDMS), gelatin, sodium acetate, lignin, and stearic acid. In some aspects, each component may be included in the composite in an amount from about 0.1% to about 80% by weight of the final composite, including about 0.2, 0.3, 0.4, 0.5, 0.6, 0.7, 0.8, 0.9, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, and 79% by weight of the final composite.

In some aspects, the material and/or composite may be further considered to include a pre-cursor liquid and/or gel form. It will be understood that the final material of the containment is a solid material, yet to become the containment or a part or layer thereof, the material can be a pre-cursor liquid or gel that allows for application as a spray or into a mold to form the containment or layer or part thereof. Accordingly, in some aspects, the material or composites may include a sprayable coating material or be formulated therein, such as in combination with a dispersant or solvent. In some aspects, the composite may be formulated in a solvent or through multiple solvents in order to address solubility and even distribution within the final composite. Examples include: water, chloroform, ethanol, acetone, toluene, hexane, and so forth. In some aspects, the solvent needs to be changed or added to in order for the components or materials to form the composite. Transitions or combinations between solvents include water to ethanol to acetone; water to ethanol to toluene; ethanol to toluene to hexane to acetone; water to choloroform to acetone to ethanol to toluene; and combinations thereof. In some aspects, transitioning the composite to an organic solvent can allow for the composite to dry through the evaporation of the organic solvent. It will be appreciated that such evaporation may be accelerated through adjusting the conditions such as heat and pressure to allow for the organic solvent to be completely removed from a final containment. Similarly, water or aqueous solutions may be evaporated from the composite in order to provide a final solid layer or containment or part thereof.

In some aspects, the composite may be of silica, such as silica nanoparticles in combination with cellulose acetate and/or a wax, such as bees wax and/or soya wax. In some aspects, the composite may be of about 2-8% silica or silica NPs, 30-70% wax, and 2-8% cellulose acetate. In some aspects, the composite may be of about 5% silica or silica NPs, 50% wax, and 5% cellulose acetate. In some aspects, hydrophobic silica, such as hydrophobic silica nanoparticles, can be used with cellulose acetate, each being of about 2-8% in the composite. In some aspects, the composite is about 5% hydrophobic silica nanoparticles and about 5% cellulose acetate. In some aspects, the composite may be of hydrophobic silica, such as nanoparticles thereof, and AKD. In some aspects, AKD is of about 5-30% and silica or silica NPs is of 2-10%.

In some aspects, the composite may include poly(vinyl) alcohol (or (polyvinyl) alcohol or PVA). In some aspects, the composite may include a combination, such as a binding agent being a combination of two materials. In some aspects, the composite may include PVA with zinc oxide and/or stearic acid. In some aspects, the composite may include PVA with glycerol, PVA with starch, PVA with starch and glycerol, PVA with halloysite nanotubes (HNTs), PVA with starch, glycerol, and HNTs, PVA with polydimethylsiloxane (PDMS), and PVA with PDMS and stearic acid. In some aspects, the composites may additionally include an oil, such as soybean oil. In some aspects, the composite may include PVA with zein. In some aspects, the composite may be of PVA with AKD nanoparticles, such as about 5-30% PVA and about 5-30% AKD nanoparticles. In some aspects, the composite may be of about 10% PVA and about 10% AKD nanoparticles. In some aspects, the combination of composite may be of PVA, AKD nanoparticles, and cellulose. In some aspects, the combination composite may include PVA with palmityl chloride, and/or polyvinyl palmitate chloride (PVPC). In some aspects, the composite may be of PVA with an AKD wax. In some aspects, the composite may be of PVA and zein and/or zein nanoparticles. In some aspects, the composite may be of PVA and xylan.

In some aspects, the composite includes PVA and one or more additional components, either alone or in combination with one or more components as set forth herein. In some aspects, PVA is from about 5 to about 80 percent by weight of the final composite or material of the containment, including about 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, and 79 percent by weight of the final composite. In some aspects, the composite is of PVA and glycerol, PVA and an AKD wax, and/or PVA and cellulose. In some aspects, such may include one or more of water, starch, and/or gelatin. In some aspects, the composite may be of PVA and glycerol, starch, and/or water. In some aspects, the composite is of PVA and glycerol, gelatin, and/or water. In some aspects, the composite is of PVA and an AKD wax, starch, and/or water. In some aspects, the composite is of PVA and an AKD wax, gelatin, and/or water. In some aspects, the composite is of PVA and glycerol, starch and/or cellulose. In some aspects, the composite is of PVA and glycerol and gelatin.

In some aspects, the composite may include PVPC. In some aspects, PVPC is from about 5 to about 80 percent by weight of the final composite or material of the containment, including about 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, and 79 percent by weight of the final composite. In some aspects, PVPC may be used in combination with silica nanoparticles, hydrophobic silica nanoparticles, AKD nanoparticles, AKD wax, AKD, EVOH, or any combination thereof. In some aspects, the composite may be of PVPC and silica. In some aspects, the composite may be of PVPC and silica nanoparticles. In some aspects, the composite may be of PVPC and hydrophobic silica nanoparticles. In some aspects, the composite may be of PVPC and AKD. In some aspects, the composite may be of PVPC and AKD nanoparticles. In some aspects, the composite may be of PVPC and AKD wax. In some aspects, the composite may be of PVPC and EVOH. In some aspects, the composite is of PVPC and AKD/AKD wax/AKD nanoparticles and EVOH. In some aspects, the composite is of PVPC, silica nanoparticles, and AKD/AKD wax/AKD nanoparticles. In some aspects, the composite is of PVPC, AKD wax, silica nanoparticles and EVOH. As set forth herein, the composite in some aspects may be prepared stepwise, such as by preparing a composite of PVPC and silica nanoparticles and then adding thereto AKD wax and/or EVOH. In some aspects, the composite is of PVPC and silica nanoparticles and EVOH, with EVOH added after the other two compounds are mixed.

In some aspects, the composite may include a polysaccharide or a polymer of saccharides, such as cellulose. In some aspects, cellulose is from about 5 to about 80 percent by weight of the final composite or material of the containment, including about 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, and 79 percent by weight of the final composite. In some aspects, cellulose may be combined with AKD, AKD wax, and/or AKD nanoparticles. In some aspects, cellulose acetate may be combined therewith. In some aspects, cellulose triacetate may be combined therewith.

In some aspects, the composite may include EVOH. In some aspects, EVOH is from about 5 to about 80 percent by weight of the final composite or material of the containment, including about 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, and 79 percent by weight of the final composite. In certain aspects, the composite may be only EVOH. In some aspects, EVOH may be combined with PHA, AKD wax, AKD, AKD nanoparticles, silica, hydrophobic silica, silica nanoparticles, hydrophobic silica nanoparticles, zein, zein nanoparticles, or combinations thereof. In some aspects, EVOH may be combined with PHA. In some aspects, PHA may be of 2-30% by weight of the resulting composite, including 3, 4, 5, 6, 7, 8, 9, 10, 11, 12, 13, 14, 15, 16, 17, 18, 19, 20, 21, 22, 23, 24, 25, 26, 27, 28, and 29%. In some aspects, the composite is of EVOH and 10% PHA. In some aspects, the composite is of EVOH and AKD wax. In some aspects, the composite is of EVOH and AKD. In some aspects, the composite is of EVOH and AKD nanoparticles. In some aspects, the composite is of EVOH and silica nanoparticles and/or hydrophobic silica nanoparticles. In some aspects, the composite is of EVOH and one or more types of nanoparticle as described herein. In some aspects, the composite is of EVOH, silica nanoparticles, and cellulose polymers and/or nanoparticles of cellulose polymers. In some aspects, the composite is of EVOH and zein and/or zein nanoparticles. In some aspects, the composite is of EVOH and PVPC.

In some aspects, the composite includes AKD, AKD wax, and/or AKD nanoparticles. In some aspects, AKD (or a wax or NPs thereof) is from about 5 to about 80 percent by weight of the final composite or material of the containment, including about 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, and 79 percent by weight of the final composite. In some aspects, the composite is of AKD nanoparticles and/or AKD wax and/or AKD. In some aspects, the composite is of AKD nanoparticles and silica nanoparticles and/or hydrophobic silica nanoparticles. In some aspects, such may further include EVOH. In some aspects, EVOH is added to an established a mix of AKD nanoparticles and silica nanoparticles and/or hydrophobic silica nanoparticles.

In some aspects, the composite includes PDMS. In some aspects, PDMS is from about 5 to about 80 percent by weight of the final composite or material of the containment, including about 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, and 79 percent by weight of the final composite. In some aspects, the composite is of PDMS and silica nanoparticles and/or hydrophobic silica nanoparticles. In some aspects, the composite is of PDMS, steric acid and silica nanoparticles and/or hydrophobic silica nanoparticles. In some aspects, the composite is of PDMS, cellulose acetate, and silica nanoparticles and/or hydrophobic silica nanoparticles. In some aspects, the composite is of PDMS, AKD, and silica nanoparticles and/or hydrophobic silica nanoparticles. In some aspects, the composite is of PDMS, cellulse triacetate, AKD, and silica nanoparticles and/or hydrophobic silica nanoparticles. In some aspects, the composite is of PDMS, starch nanoparticles, and silica nanoparticles and/or hydrophobic silica nanoparticles. In some aspects, the composite is of PDMS and AKD. In some aspects, the composite is of PDMS, starch nanoparticles, and EVOH. In some aspects, the composite is of about 50 to 80% PDMS and AKD, such as about 55, 60, 65, 70, and 75% PDMS. In some aspects, the composite is of about 70% PDMS and AKD.

In some aspects, the composite may include a polysaccharide or a polymer of saccharides, including agar, starches, cellulose and cellulose derivatives, and/or agar.

In some aspects, the composite may include a cellulose-based polysaccharide, such as cellulose, cellulose acetate, and/or cellulose triacetate. In some aspects, cellulose, cellulose acetate, carboxy methyl cellulose, or cellulose triacetate is from about 5 to about 80 percent by weight of the final composite or material of the containment, including about 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, and 79 percent by weight of the final composite. In some aspects, cellulose may be combined with AKD, AKD wax, and/or AKD nanoparticles. In some aspects, cellulose acetate may be combined with AKD, AKD wax, and/or AKD nanoparticles. In some aspects, cellulose triacetate may be combined with AKD, AKD wax, and/or AKD nanoparticles.

In some aspects, the composite may include a starch-based polysaccharide, including starches obtained from plants and vegetables, such as tree, tubers, corn, barley, wheat, cereal grains, and root vegetables. In some aspects, the starch is derived from yams, maize, cassava, corn, palm trees (such as Palm Sago), or a combination thereof. In some aspects, starch is from about 5 to about 80 percent by weight of the final composite or material of the containment, including about 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, and 79 percent by weight of the final composite. In aspects, the starch is water-soluble, water-insoluble, or a combination thereof. In some aspects, a starch may be combined with AZC. In some aspects, a starch may be combined with lignin and/or glycerol and/or AZC. In some aspects, a soluble starch may be combined with AZC. In some aspects, a soluble starch may be combined with lignin and/or glycerol and/or AZC.

In some aspects, the composite is of starch, such as corn starch, yam starch, palm starch, maize starch, and/or cassava starch, with gelatin. Such may be formulated in an aqueous solution and forms a gel. In some aspects, chloroform may then be added to a gelatin and starch gel along with cellulose acetate and/or sodium acetate. In some aspects, the composite is of corn starch, gelatin, chloroform and cellulose acetate. In some aspects, the composite is of corn starch, gelatin, chloroform and sodium acetate. In some aspects, the composite is of cassava starch, gelatin, chloroform and cellulose acetate. In some aspects, the composite is of cassava starch, gelatin, chloroform and sodium acetate. In some aspects, the composite is of yam starch, gelatin, chloroform and cellulose acetate. In some aspects, the composite is of yam starch, gelatin, chloroform and sodium acetate. In some aspects, the composite is of palm starch, gelatin, chloroform and cellulose acetate. In some aspects, the composite is of palm starch, gelatin, chloroform and sodium acetate. In some aspects, the composite is of maize starch, gelatin, chloroform and cellulose acetate. In some aspects, the composite is of maize starch, gelatin, chloroform and sodium acetate.

In some aspects, the composite is of starch, such as corn starch, yam starch, palm starch, maize starch, and/or cassava starch, with glycerol. Such may be formulated in an aqueous solution and forms a gel. In some aspects, chloroform may then be added to a glycerol and starch gel along with cellulose acetate and/or sodium acetate. In some aspects, the composite is of corn starch, gelatin, chloroform and cellulose acetate. In some aspects, the composite is of corn starch, glycerol, chloroform and sodium acetate. In some aspects, the composite is of cassava starch, glycerol, chloroform and cellulose acetate. In some aspects, the composite is of cassava starch, glycerol, chloroform and sodium acetate. In some aspects, the composite is of yam starch, glycerol, chloroform and cellulose acetate. In some aspects, the composite is of yam starch, glycerol, chloroform and sodium acetate. In some aspects, the composite is of palm starch, glycerol, chloroform and cellulose acetate. In some aspects, the composite is of palm starch, glycerol, chloroform and sodium acetate. In some aspects, the composite is of maize starch, glycerol, chloroform and cellulose acetate. In some aspects, the composite is of maize starch, glycerol, chloroform and sodium acetate.

In some aspects, the composite is of starch, such as corn starch, yam starch, palm starch, maize starch, and/or cassava starch, with gelatin and glycerol. Such may be formulated in an aqueous solution and forms a gel. In some aspects, chloroform may then be added to a gelatin, glycerol, and starch gel along with cellulose acetate and/or sodium acetate. In some aspects, the composite is of corn starch, gelatin, glycerol, chloroform and cellulose acetate. In some aspects, the composite is of corn starch, gelatin, glycerol, chloroform and sodium acetate. In some aspects, the composite is of cassava starch, gelatin, glycerol, chloroform and cellulose acetate. In some aspects, the composite is of cassava starch, gelatin, glycerol, chloroform and sodium acetate. In some aspects, the composite is of yam starch, gelatin, glycerol, chloroform and cellulose acetate. In some aspects, the composite is of palm starch, gelatin, glycerol, chloroform and sodium acetate. In some aspects, the composite is of maize starch, gelatin, glycerol, chloroform and sodium acetate.

In some aspects, the composite is of starch, such as corn starch, yam starch, palm starch, maize starch, and/or cassava starch, with PVA and/or AKD and/or glycerol. In some aspects, such composites may further include an acetate, such as cellulose acetate or sodium acetate. As described herein, an acetate can be added by including chloroform and/or sorbitol when mixed with the preformed gel of the other components.

In some aspects, the composite is of a starch, PVA, and glycerol. In some aspects, the composite is of yam starch, PVA, and glycerol. In some aspects, the composite is of maize starch, PVA, and glycerol. In some aspects, the composite is of corn starch, PVA, and glycerol. In some aspects, the composite is of palm starch, PVA, and glycerol. In some aspects, the composite is of cassava starch, PVA, and glycerol. In some aspects, the composite is of yam starch, PVA, glycerol, chloroform, and cellulose acetate. In some aspects, the composite is of yam starch, PVA, glycerol, chloroform, and sodium acetate. In some aspects, the composite is of maize starch, PVA, glycerol, chloroform, and cellulose acetate. In some aspects, the composite is of maize starch, PVA, glycerol, chloroform, and sodium acetate. In some aspects, the composite is of corn starch, PVA, glycerol, chloroform, and cellulose acetate. In some aspects, the composite is of corn starch, PVA, glycerol, chloroform, and sodium acetate. In some aspects, the composite is of palm starch, PVA, glycerol, chloroform, and cellulose acetate. In some aspects, the composite is of palm starch, PVA, glycerol, chloroform, and sodium acetate. In some aspects, the composite is of cassava starch, PVA, glycerol, chloroform, and cellulose acetate. In some aspects, the composite is of cassava starch, PVA, glycerol, chloroform, and sodium acetate.

In some aspects, the composite is of a starch, PVA, and AKD. In some aspects, the composite is of yam starch, PVA, and AKD. In some aspects, the composite is of maize starch, PVA, and AKD. In some aspects, the composite is of corn starch, PVA, and AKD. In some aspects, the composite is of palm starch, PVA, and AKD. In some aspects, the composite is of cassava starch, PVA, and AKD. In some aspects, the composite is of yam starch, PVA, AKD, chloroform, and cellulose acetate. In some aspects, the composite is of yam starch, PVA, AKD, chloroform, and sodium acetate. In some aspects, the composite is of maize starch, PVA, AKD, chloroform, and cellulose acetate. In some aspects, the composite is of maize starch, PVA, AKD, chloroform, and sodium acetate. In some aspects, the composite is of corn starch, PVA, AKD, chloroform, and cellulose acetate. In some aspects, the composite is of corn starch, PVA, AKD, chloroform, and sodium acetate. In some aspects, the composite is of palm starch, PVA, AKD, chloroform, and cellulose acetate. In some aspects, the composite is of palm starch, PVA, AKD, chloroform, and sodium acetate. In some aspects, the composite is of cassava starch, PVA, AKD, chloroform, and cellulose acetate. In some aspects, the composite is of cassava starch, PVA, AKD, chloroform, and sodium acetate.

In some aspects, the composite is of a starch, PVA, gelatin, and AKD. In some aspects, the composite is of yam starch, PVA, gelatin, and AKD. In some aspects, the composite is of maize starch, PVA, gelatin, and AKD. In some aspects, the composite is of corn starch, PVA, gelatin, and AKD. In some aspects, the composite is of palm starch, PVA, gelatin, and AKD. In some aspects, the composite is of cassava starch, PVA, gelatin, and AKD. In some aspects, the composite is of yam starch, PVA, gelatin, AKD, chloroform, and cellulose acetate. In some aspects, the composite is of yam starch, PVA, gelatin, AKD, chloroform, and sodium acetate. In some aspects, the composite is of maize starch, PVA, gelatin, AKD, chloroform, and cellulose acetate. In some aspects, the composite is of maize starch, PVA, gelatin, AKD, chloroform, and sodium acetate. In some aspects, the composite is of corn starch, PVA, gelatin, AKD, chloroform, and cellulose acetate. In some aspects, the composite is of corn starch, PVA, gelatin, AKD, chloroform, and sodium acetate. In some aspects, the composite is of palm starch, PVA, gelatin, AKD, chloroform, and cellulose acetate. In some aspects, the composite is of palm starch, PVA, gelatin, AKD, chloroform, and sodium acetate. In some aspects, the composite is of cassava starch, PVA, gelatin, AKD, chloroform, and cellulose acetate. In some aspects, the composite is of cassava starch, PVA, gelatin, AKD, chloroform, and sodium acetate.

In some aspects, the composite is of a starch, PVA, gelatin, and glycerol. In some aspects, the composite is formed with ethanol and/or water as the solvent. In some aspects, the composite is of yam starch, PVA, gelatin, and glycerol. In some aspects, the composite is of corn starch, PVA, gelatin, and glycerol. In some aspects, the composite is of maize starch, PVA, gelatin, and glycerol. In some aspects, the composite is of palm starch, PVA, gelatin, and glycerol. In some aspects, the composite is of cassava starch, PVA, gelatin, and glycerol.

In some aspects, the composite is of a starch, PVA, glycerol, and AKD. In some aspects, the composite is formed with ethanol and/or water as the solvent. In some aspects, the composite is of yam starch, PVA, glycerol, and AKD. In some aspects, the composite is of corn starch, PVA, glycerol, and AKD. In some aspects, the composite is of maize starch, PVA, glycerol, and AKD. In some aspects, the composite is of palm starch, PVA, glycerol, and AKD. In some aspects, the composite is of cassava starch, PVA, glycerol, and AKD.

In some aspects, the composite is of a starch, gelatin, and glycerol. In some aspects, the composite is formed with ethanol and/or water as the solvent. In some aspects, the composite is of yam starch, gelatin, and glycerol. In some aspects, the composite is of corn starch, gelatin, and glycerol. In some aspects, the composite is of maize starch, gelatin, and glycerol. In some aspects, the composite is of palm starch, gelatin, and glycerol. In some aspects, the composite is of cassava starch, gelatin, and glycerol.

In some aspects, the composite is of palm root, gelatin, and glycerol.

In some aspects, the composite is of tapioca, gelatin, and glycerol. In some aspects, the composite is formed with ethanol and/or water as the solvent.

In some aspects, the composite is of a gelatin, PVA, and glycerol. In some aspects, the composite is of a gelatin, PVA, glycerol, and AKD.

In some aspects, the composite is of AKD, PVA, and TEOS. In some aspects, the composite is formed with ethanol and/or water as the solvent.

In some aspects, the composite is of AKD, PVA, gelatin, and AKD.

In some aspects, the composite is of a wax, PVA, TEOS, and AKD. In some aspects, the composite is formed with ethanol and/or water as the solvent.

In some aspects, the composite is of agar, with gelatin. Such may be formulated in an aqueous solution and forms a gel. In some aspects, the composite is of a gelatin and agar gel along with cellulose acetate and/or sodium acetate. In some aspects, chloroform may then be added to a gelatin and agar gel along with cellulose acetate and/or sodium acetate. In some aspects, the composite is of agar, gelatin, chloroform and cellulose acetate. In some aspects, the composite is of agar, gelatin, chloroform and sodium acetate.

In some aspects, the composite is of lignin. In some aspects, the composite is of lignin and glycerol and/or gelatin. In some aspects, the composite is of lignin, glycerol and/or gelatin, and cellulose acetate and/or sodium acetate. In some aspects, the composite is of lignin, glycerol and/or gelatin, starch, and cellulose acetate and/or sodium acetate. In some aspects, the composite is of lignin, starch, and sorbitol. In some aspects, the composite is of lignin, starch, sorbitol, and cellulose acetate and/or sodium acetate.

In some aspects, the composites may include cellulose nanofibers and nano clay. In some aspects, the materials may include chitosan. In some aspects, the composites may include cellulose ester(s). In some aspects, the composites may include chitosan-graft and PDMS. In some aspects, the composites may include zein. In some aspects, the composites may include PDMS and zein. In some aspects, the composites may include chitosan and zein. In some aspects, the composites may include PDMS and zein and chitosan. In some aspects, the composites may include PLA and PCL. In some aspects, the composites may be a sprayable material that include one or more of PVA, ZnO, stearic acid, glycerol, starch, HNTs, PDMS, soybean oil, zein, chitosan, nano clay, cellulose nanofibers, cellulose ester(s), PLA, and/or PCL.

In some aspects, the material may include a non-degradable coating, such as silicon oxide (SiOx), polyvinylidene chloride (PVDC), ethylene vinyl alcohol (EVOH), and/or one or more polyolefins.

### Biopolymers

In some aspects, the containments of the present disclosure may include a biopolymer. The biopolymer can be provided as a layer, such as an external layer, an internal layer, and/or an intermediate layer. In some aspects, the biopolymer may be part of the material composites as set forth herein. In some aspects, a containment may include a biopolymer layer and a material layer. In some aspects, a containment may include a material layer that includes a biopolymer and a biopolymer layer.

Biopolymers or biopolymer composites of two or more biopolymers are formed by cross-linking monomeric units. Cross-linking can occur through chemical and/or physical processes, such as by providing an initiator, a crosslinking agent, UV radiation, heat, light, agitation, and so forth. In some aspects, a biopolymer composite is formed through combining two or more monomers and initiating cross-linking thereof. As used herein, “biopolymer” accordingly refers to polymers of both cross-linked monomers and cross-linked composites of two or more monomers. In some aspects, a biopolymer refers to a cross-linked polymer of at least one of polyhydroxyalkanote (PHA), poly(hydroxybutyrate-co-hydroxy valerate (PHBV), polybutylene succinate (PBS), lignin, starch, polyhydroxybutyrate (PHB), PHBH (random copolymer of (R)-3-hydroxybutyrate and (R)-3-hydroxyhexanoate), polylactic acid (PLA), polybutylene adipate terephthalate (PBAT), PBST (polybutylene succinate-co-terephthalate), PBSA (polybutylene succinate-co-butylene adipate), polybutylene terephthalate (PBT), poly(vinyl) alcohol (PVA), poly(glycolic acid) (PGA), chitosan, polycaprolactone (PCL), and combinations thereof

In some aspects, the biopolymer is of a single compound or a composite of two or more polymeric compounds. In some aspects, the polymeric compound is one or more of polyhydroxyalkanoate (PHA), a PHA-type polymer, such as poly-hydroxybutyrate-co-hydroxy valerate (PHBV), polybutylene succinate (PBS), lignin, starch, polyhydroxybutyrate (PHB), PHBH (random copolymer of (R)-3-hydroxybutyrate and (R)-3-hydroxyhexanoate), polylactic acid (PLA), polybutylene adipate terephthalate (PBAT), PBST (polybutylene succinate-co-terephthalate), PBSA (polybutylene succinate-co-butylene adipate), polybutylene terephthalate (PBT), poly(vinyl) alcohol (PVA), poly(glycolic acid) (PGA), chitosan, polycaprolactone (PCL), and combinations thereof. In some aspects, the biopolymer may include a cofactor. A cofactor may include a material as described herein. In some aspects, the biopolymer may include one or more of carbon nanofibers (CNF), silicon dioxide nanoparticles, copper oxide nanoparticles (including CuO and/or Cu₂O), titanium dioxide nanoparticles, magnesium oxide nanoparticles, nano clays (nano-layered silicates), and/or chitosan.

In some aspects, the biopolymer is of a single polymeric compound, such as 100% PBS, 100% PHA, 100% PHBV, 100% lignin, 100% PLA, 100% PHB, 100% PBAT, 100% PBSA, 100% PCL, 100% PGA, 100% PHBH, 100% PBST, 100% or other biopolymer. In other aspects, the biopolymer is a composite of two or more polymeric compounds. It will be appreciated that variance in the amount of polymeric compound can in turn provide different qualities to the resulting biopolymer. In some aspects, the biopolymer may be of from about 10 to about 90 f 10% wt % PHA, including about 15, 20, 25, 30, 35, 40, 45, 50, 55, 60, 65, 70, 75, 80, and 85 wt % PHA. In some aspects, the biopolymer may be of from about 10 to about 90 wt %±10% PBS, including about 15, 20, 25, 30, 35, 40, 45, 50, 55, 60, 65, 70, 75, 80, and 85 wt % PBS. In some aspects, the biopolymer may be of from about 10 to about 90 wt %±10% lignin, including about 15, 20, 25, 30, 35, 40, 45, 50, 55, 60, 65, 70, 75, 80, and 85 wt % lignin. In some aspects, the biopolymer may be of from about 10 to about 90 wt %±10% PLA, including about 15, 20, 25, 30, 35, 40, 45, 50, 55, 60, 65, 70, 75, 80, and 85 wt % PLA. In some aspects, the biopolymer may be of from about 10 to about 90 wt %±10% PHBV, including about 15, 20, 25, 30, 35, 40, 45, 50, 55, 60, 65, 70, 75, 80, and 85 wt % PHBV. In some aspects, the biopolymer may be a composite to about 20 to about 80 wt %±10% PHA with about 20 to about 80 wt %±10% PBS. In some aspects, the biopolymer may be a composite to about 20 to about 80 wt %±10% PHA with about 20 to about 80 wt % 10% lignin. In some aspects, the biopolymer may be a composite to about 20 to about 80 wt % PBS with about 20 to about 80 wt %±10% lignin. In some aspects, the biopolymer may be a composite to about 20 to about 80 wt %±10% PHA with about 20 to about 80 wt %±10% PBS and about 20 to about 80 wt %±10% lignin.

In some aspects, the biopolymer may be a composite of about 90 wt %±10% PLA with about 10 wt %±10% PHA. In some aspects, the biopolymer may be a composite of about 80 wt %±10% PLA with about 20 wt %±10% PHA. In some aspects, the biopolymer may be a composite of about 75 wt %±10% PLA with about 25 wt %±10% PHA. In some aspects, the biopolymer may be a composite of about 70 wt %±10% PLA with about 30 wt %±10% PHA. In some aspects, the biopolymer may be a composite of about 65 wt %±10% PLA with about 35 wt %±10% PHA. In some aspects, the biopolymer may be a composite of about 60 wt %±10% PLA with about 40 wt %±10% PHA. In some aspects, the PHA may include PHB and/or PHBH. In some aspects, the biopolymer may be a composite of about 85 wt %±10% PLA with about 15 wt %±10% PHA/PHB/PHBH. In some aspects, the biopolymer may be a composite to about 80 wt %±10% PLA with about 20 wt %±10% PHA/PHB/PHBH. In some aspects, the biopolymer may be a composite to about 75 wt %±10% PLA with about 25 wt %±10% PHA/PHB/PHBH. In some aspects, the biopolymer may be a composite of about 70 wt %±10% PLA with about 30 wt %±10% PHA/PHB/PHBH, the biopolymer may be a composite of about 60 wt %±10% PLA with about 40 wt %±10% PHA/PHB/PHBH, the biopolymer may be a composite of about 50 wt % 10% PLA with about 50 wt % 10% PHA/PHB/PHBH, the biopolymer may be a composite of about 40 wt %±10% PLA with about 60 wt %±10% PHA/PHB/PHBH, the biopolymer may be a composite of about 30 wt %±10% PLA with about 30 wt %±10% PHA/PHB/PHBH.

In some aspects, the biopolymer may be a composite of about 90 wt %±10% PLA with about 10 wt %±10% PBS. In some aspects, the biopolymer may be a composite of about 80 wt %±10% PLA with about 20 wt %±10% PBS. In some aspects, the biopolymer may be a composite of about 85 wt %±10% PLA with about 15 wt %±10% PBS. In some aspects, the biopolymer may be a composite to about 80 wt %±10% PLA with about 20 wt %±10% PBS. In some aspects, the biopolymer may be a composite to about 75 wt %±10% PLA with about 25 wt %±10% PBS. In some aspects, the biopolymer may be a composite of about 70 wt %±10% PLA with about 30 wt %±10% PBS. In some aspects, the biopolymer may be a composite of about 65 wt %±10% PLA with about 35 wt %±10% PBS. In some aspects, the biopolymer may be a composite of about 60 wt %±10% PLA with about 40 wt %±10% PBS. In some aspects, the biopolymer may be a composite of about 50 wt %±10% PLA with about 50 wt %±10% PBS. In some aspects, the biopolymer may be a composite of about 40 wt %±10% PLA with about 60 wt %±10% PBS. In some aspects, the biopolymer may be a composite of about 30 wt %±10% PLA with about 70 wt %±10% PBS.

In some aspects, the biopolymer may be a composite of about 90 wt %±10% PLA with about 10 wt %±10% PBAT. In some aspects, the biopolymer may be a composite of about 80 wt %±10% PLA with about 20 wt %±10% PBAT. In some aspects, the biopolymer may be a composite of about 85 wt %±10% PLA with about 15 wt %±10% PBAT. In some aspects, the biopolymer may be a composite to about 80 wt %±10% PLA with about 20 wt %±10% PBAT. In some aspects, the biopolymer may be a composite to about 75 wt %±10% PLA with about 25 wt %±10% PBAT. In some aspects, the biopolymer may be a composite of about 70 wt %±10% PLA with about 30 wt %±10% PBAT. In some aspects, the biopolymer may be a composite of about 60 wt % 10% PLA with about 40 wt % 10% PBAT. In some aspects, the biopolymer may be a composite of about 50 wt %±10% PLA with about 50 wt %±10% PBAT. In some aspects, the biopolymer may be a composite of about 40 wt %±10% PLA with about 60 wt %±10% PBAT. In some aspects, the biopolymer may be a composite of about 30 wt %±10% PLA with about 70 wt % a 10% PBAT.

In some aspects, the biopolymer may be of polybutylene adipate terephthalate (PBAT) or a composite including PBAT. In some aspects, the biopolymer may be of about 0 to about 70 wt % PBAT, including about 5, 10, 15, 20, 25, 30, 35, 40, 45, 50, 55, 60, and 65 wt %. In some aspects, PBAT may be included with PBS, such as at a ratio of about 1:1, 1:2, 1:3, 1:4, 1:5, 1:6, 1:7, 1:8, 1:9 and 1:10, or at a ratio of about 2:1, 3:1, 4:1, 5:1, 6:1, 7:1, 8:1, 9:1, or 10:1.

In some aspects, the biopolymer may be a composite of about 10 to about 20 wt % PBAT and/or PBS, with about 60 to about 70 wt % PLA and about 10 to about 20 wt % PHA.

In some aspects, the biopolymer includes a further agent or cofactor. Such may include one or more of a blowing additive and a mold release agent. In some aspects, the biopolymer may be a composite of about 10 to about 20 wt % PBAT and/or PBS, with about 60 to about 70 wt % PLA, about 10 to about 20 wt % PHA, about 10 to 20 wt % blowing additives and abut 5 to about 10 t % mold release agent. In some aspects, the biopolymer may be of 100% PHA. In some aspects, the biopolymer may be of about 85 wt % PLA, about 10 wt % PBS and about 5 wt % blowing additives. In some aspects, the biopolymer may be of about 85 wt % PLA, about 10 wt % PHA and about 5 wt % blowing additives. In some aspects, the biopolymer may be of about 85 wt % PLA, about 10 wt % PBAT and about 5 wt % blowing additives. In some aspects, the biopolymer may be of about 85 wt % PLA, about 10 wt % PHBV and about 5 wt % blowing additives. In some aspects, the biopolymer may be of about 70 to about 80 wt % PLA, about 10 to about 20 wt % PHBV and about 10 wt % blowing additives.

In some aspects, the biopolymer may be a composite of about 70 wt % PBAT, about 10 wt % PHA, about 10 wt % PBS and about 10 wt % blowing additive.

In some aspects, the biopolymer may be of about 10 wt % PLA, about 60 wt % PBAT, about 10 wt % PHA, about 10 wt % PBS and about 10 wt % blowing additives.

In some aspects, the biopolymer may be of about 20 to about 30 wt % PLA, about 50 wt % PBAT, about 20 wt % PHA/PBS and about 5 to about 10 wt % blowing additives.

In some aspects, the biopolymer may be a composite of about 30 to about 40 wt % PLA, about 40 wt % PHA, about 10 to about 20 wt % PBAT, and about 5 to about 10 wt % blowing additives.

In some aspects, the biopolymer may be a composite of about 60 to about 70 wt % PHA/PBS, about 30 wt % PBAT, and about 5 to 10 wt % blowing additives.

In some aspects, the biopolymer is a composite of about 100 wt % PLA, PBAT, PHA, PBS, or other biopolymer.

In some aspects, the biopolymer is a composite of about 50 to about 60 wt % PLA, about 50 to about 60 wt % PHA.

In some aspects, such as where the containment is a lid or drink containment, a neck closure may be included. In some aspects, the neck closure may be a composite of the biopolymers as set forth herein. In some aspects, the neck closure is of PBS, PBAT and/or PHA.

In some aspects, the biopolymer is a composite of about 90% PLA and about 10% PHA and/or PHB and/or PHBH; about 85% PLA and about 15% PHA and/or PHB and/or PHBH; about 80% PLA and about 20% PHA and/or PHB and/or PHBH; about 75% PLA and about 25% PHA and/or PHB and/or PHBH; or, about 70% PLA and about 30% PHA and/or PHB and/or PHBH. It will be appreciated that the cap may include and/or be coated with one or more of the materials as described herein, including the composites and parts thereof the material layer.

In some aspects, the biopolymer layer may be a composite of a biopolymer and a material. Such may include any biopolymer or composite thereof as set forth herein and any material as set forth herein. Such composites may be considered a combination of the biopolymer and the material layers, although in some aspects, the containment may include independent biopolymer and/or material layers as well.

In some aspects, the biopolymer is a composite of one or more biopolymers and one or more materials. In some aspects, the composite may be of PLA and PHA and/or PHB and/or PHBH and carbon nanofibers to provide a fully bio-based and biodegradable nano composite, with high modulus and large aspect ratio, good thermal stability, and enhanced water vapor/oxygen barrier property. In some aspects, the composite may be of PLA and PHA and/or PHB and/or PHBH and silicon dioxide nanoparticles for good water vapor/oxygen barrier properties. In some aspects, the composite may be of PLA and PHA and/or PHB and/or PHBH and CuO and/or Cu₂O nanoparticles to provide antibacterial and/or antifungal properties, as well as good thermal stability and good gas/vapor barrier properties. In some aspects, the composite may be of PLA and PHA and/or PHB and/or PHBH and TiO₂ to provide decreased water vapor permeability, increased tensile strength, improved barrier property and antibacterial activity. In some aspects, the composite may be of PLA and PHA and/or PHB and/or PHBH and ZnO nanoparticles to provide improve shelf life and reduce WvTR (water vapor transmission rate) and OTR (oxygen transmission rate). In some aspects, the composite may be of PLA and PHA and/or PHB and/or PHBH and MgO nanoparticles to provide improved oxygen and water vapor barrier properties, anti-bacterial and anti-fungal properties, good tensile strength, and plasticity. In some aspects, the composite may be of PLA and PHA and/or PHB and/or PHBH and nano clays to provide antimicrobial activity and good barrier properties. In some aspects, the composite may be of PLA and PHA and/or PHB and/or PHBH and chitosan to provide good barrier properties.

In some aspects, the containment may be heat sealed once assembled. In some aspects, the biopolymer may be applied as a single film or sprayed onto a surface. In some aspects, a biopolymer film or spray within an interior portion of a pulp shell or portion thereof. In such aspects, application of heat sealing can assist in the assembly of the complete structure. Such processes can be performed without negatively impacting the degradability of the containment, while adding optional functionalities to the containment. In some aspects, heat sealing may improve seal effectiveness, production efficiency, and reduce cost. Heat sealing on the interior and/or exterior surfaces of the containment may improve bonding between the layers and production productivity. Heat sealing may further eliminate any need for applying an adhesive material to fuse the layers. In some aspects, the heat sealing is applied to a biopolymer layer as described herein. It will be appreciated that other adhesives may be utilized to assemble the container, either alone or in combination with the heat sealed biopolymer.

In some aspects, the heat sealing occurs at a temperature above the melting point of the biopolymer. Heat sealing may be controlled by at least three factors of temperature, duration and pressure. In some aspects, the duration may include the time to raise the temperature, to achieve melting of the biopolymer and to allow for cooling and solidification of the biopolymer. In some aspects, pressure is applied evenly to the biopolymer as the temperature rises and melting is achieved. Even pressure allows for even distribution of the biopolymer.

In some aspects, the containment may be a plurality of parts assembled together. The parts may be identical or asymmetrical. In some aspects, the plurality of parts may include two halves of a containment, such as two semi-cylinders with a half base, such as semi-circle. It will be appreciated that application of pressure and temperature within containment and/or externally to the containment allows for the biopolymer layers from the assemble parts to mix and once cooled hold the parts of the assembled containment together.

In some aspects, the present disclosure may include a lid or cap for a containment. In some aspects, the lid or cap may be constructed of the same or a similar material as the body of the containment. In some aspects, the lid is made of pulp, pulp and a composite, pulp and a biopolymer, a composite, a composite and a biopolymer, a biopolymer, or all three.

In some aspects, a lid may include an internal thread to allow for the cap to screw on to an external thread at the opening of the containment. For example, the biopolymer, material, and/or pulp may include an external thread for a cap to be secured thereto.

In some aspects, the cap is of a biopolymer or contains a layer thereof therein. In some aspects, the cap may be of an biopolymer as set forth herein. In some aspects, the cap is made of PHA, such as 100% PHA. In some aspects, the cap is made of PBS, such as 100% PBS. In some aspects, the cap is made of PBAT, such as 100% PBAT. In some aspects, the cap is made of PLA and PHA, such as 90% PLA and 10% PHA, 80% PLA and 20% PHA, 70% PLA and 30% PHA, 60% PLA and 40% PHA, and 50% PLA and 50% PHA. In some aspects, the cap is made of PLA and PBS, such as 90% PLA and 10% PBS, 80% PLA and 20% PBS, 70% PLA and 30% PBS, 60% PLA and 40% PBS, and 50% PLA and 50% PBS. In some aspects, the cap is made of PLA and PBAT, such as 90% PLA and 10% PBAT, 80% PLA and 20% PBAT, 70% PLA and 30% PBAT, 60% PLA and 40% PBAT, and 50% PLA and 50% PBAT.

### Examples

Table 1 below provides examples of the composites of the present disclosure. The composites are used as a material either alone or in combination with a biopolymer and/or pulp to form a containment.

TABLE 1

| Binding | | Structural | | | |
|---|---|---|---|---|---|
| Agent | Active Agent | Agent | Gelatinizer | Plasticizer | Solvent Scheme |
| Natural Wax | Silica | Cellulose | | | WATER- |
| (Soya & | Nanoparticles | Acetate | | | ETHANOL- |
| Bees) | | | | | ACETONE |
| | Silica | Cellulose | | | WATER- |
| | Nanoparticles | Acetate | | | ETHANOL- |
| | | | | | ACETONE |
| AKD | Silica | Cellulose | | | WATER- |
| | Nanoparticles | Acetate | | | ETHANOL- |
| | | | | | TOLUENE |
| AKD | | Cellulose | PVA | | WATER- |
| | | Acetate | | | ETHANOL- |
| | | | | | TOLUENE |
| AKD | AKD | Cellulose | | | WATER- |
| | nanoparticles | Acetate | | | ETHANOL- |
| | | | | | TOLUENE |
| | | Palmityl | PVA + PVPC | | WATER- |
| | | chloride | | | ETHANOL- |
| | | | | | ACETONE |
| | Silica | Cellulose | PVPC | | WATER- |
| | Nanoparticles | Acetate | | | ETHANOL- |
| | | | | | ACETONE |
| AKD | | Cellulose | PVPC | | WATER- |
| | | Acetate | | | ETHANOL- |
| | | | | | TOLUENE |
| Maize Starch | | Cellulose | AZC | | WATER- |
| | | Acetate | | | ETHANOL- |
| | | | | | ACETONE |
| Maize Starch | Lignin | Cellulose | Maize Starch | Glycerol | WATER- |
| | | Acetate | | | ETHANOL- |
| | | | | | ACETONE |
| | | Cellulose | PVA | Xylane | WATER- |
| | | Acetate | | | ETHANOL- |
| | | | | | ACETONE |
| AKD | | Cellulose | PVA | | WATER- |
| | | Acetate | | | ETHANOL- |
| | | | | | ACETONE |
| AKD | | Cellulose | PVPC | | WATER- |
| | | Acetate | | | ETHANOL- |
| | | | | | TOLUENE |
| | | Cellulose | PVPC | Xylane | WATER- |
| | | Acetate | | | ETHANOL- |
| | | | | | ACETONE |
| EVOH | EVOH | Cellulose | PHA | | WATER- |
| | | Acetate | | | ETHANOL- |
| | | | | | ACETONE |
| AKD | EVOH | Cellulose | | | WATER- |
| | | Acetate | | | ETHANOL- |
| | | | | | ACETONE |
| EVOH | EVOH | Cellulose | | | WATER- |
| | | Acetate | | | ETHANOL- |
| | | | | | ACETONE |
| EVOH | EVOH/AKD | Cellulose | | | WATER- |
| | nanoparticles | Acetate | | | ETHANOL- |
| | | | | | ACETONE |
| EVOH | EVOH/silica | Cellulose | | | WATER- |
| | nanoparticles | Acetate | | | ETHANOL- |
| | | | | | ACETONE |
| EVOH | EVOH/silica | Cellulose | Cellulose | | WATER- |
| | nanoparticles | Acetate | | | ETHANOL- |
| | | | | | ACETONE |
| EVOH | EVOH/zein | Cellulose | | | WATER- |
| | nanoparticles | Acetate | | | ETHANOL- |
| | | | | | ACETONE |
| | Zein | Cellulose | PVA | | WATER- |
| | nanoparticles | Acetate | | | ETHANOL- |
| | | | | | ACETONE |
| EVOH | EVOH | Cellulose | PVPC | | WATER- |
| | | Acetate | | | ETHANOL- |
| | | | | | ACETONE |
| AKD | | Cellulose | PVA | | WATER- |
| | | Acetate | | | ETHANOL- |
| | | | | | ACETONE |
| AKD | | Cellulose | PHA | | WATER- |
| | | Acetate | | | ETHANOL- |
| | | | | | ACETONE |
| AKD | EVOH | Cellulose | PVPC | | WATER- |
| | | Acetate | | | ETHANOL- |
| | | | | | ACETONE |
| AKD | Silica | Cellulose | PVPC | | WATER- |
| | nanoparticle | Acetate | | | ETHANOL- |
| | | | | | ACETONE |
| AKD | Silica | Cellulose | PVPC | | WATER- |
| | nanoparticle/ | Acetate | | | ETHANOL- |
| | EVOH | | | | ACETONE |
| | Silica | Cellulose | PVPC | | WATER- |
| | nanoparticle/ | Acetate | | | ETHANOL- |
| | EVOH | | | | ACETONE |
| EVOH | Silica | Cellulose | PVPC | | WATER- |
| | nanoparticle/ | Acetate | | | ETHANOL- |
| | EVOH/AKD | | | | ACETONE |
| | Nanoparticles | | | | |
| | EVOH/AKD | Cellulose | PVPC | | WATER- |
| | Nanoparticles | Acetate | | | ETHANOL- |
| | | | | | ACETONE |
| | AKD nano | Cellulose | | | WATER- |
| | particles/Silica | Acetate | | | ETHANOL- |
| | nanoparticles/ | | | | ACETONE |
| | EVOH | | | | |
| | AKD | Cellulose | | | WATER- |
| | nanoparticles | Acetate | | | ETHANOL- |
| | | | | | ACETONE |
| PDMS | Silica | Cellulose | | | ETHANOL- |
| | nanoparticles | Acetate | | | TOLUENE- |
| | | | | | HEXANE- |
| | | | | | ACETONE |
| PDMS | Silica | Cellulose | Stearic Acid | | ETHANOL- |
| | nanoparticles | Acetate | | | TOLUENE- |
| | | | | | HEXANE- |
| | | | | | ACETONE |
| PDMS | silica | cellulose | | | ETHANOL- |
| | nanoparticles | acetate | | | TOLUENE- |
| | | | | | HEXANE- |
| | | | | | ACETONE |
| AKD | silica | Cellulose | PDMS | | ETHANOL- |
| | nanoparticles | Acetate | | | TOLUENE- |
| | | | | | HEXANE- |
| | | | | | ACETONE |
| AKD | silica | Cellulose | PDMS | | ETHANOL- |
| | nanoparticles | Triacetate | | | TOLUENE- |
| | | | | | HEXANE- |
| | | | | | ACETONE |
| PDMS | starch | Cellulose | PDMS | | ETHANOL- |
| | nanoparticles/ | Triacetate | | | TOLUENE- |
| | silica | | | | HEXANE- |
| | nanoparticles | | | | ACETONE |
| AKD | starch | Cellulose | PDMS | | ETHANOL- |
| | nanoparticles/ | Acetate | | | TOLUENE- |
| | silica | | | | HEXANE- |
| | nanoparticles | | | | ACETONE |
| PDMS | starch | Cellulose | EVOH | | ETHANOL- |
| | nanoparticles/ | Acetate | | | TOLUENE- |
| | silica | | | | HEXANE- |
| | nanoparticles | | | | ACETONE |
| AKD | | Cellulose | PDMS | | ETHANOL- |
| | | Acetate | | | TOLUENE- |
| | | | | | HEXANE- |
| | | | | | ACETONE |
| Starch | Starch/PVA | Cellulose | Starch | Glycerol | Water |
| | | Acetate | | | |
| Gelatin | Gelatin/PVA | Cellulose | Gelatin | Glycerol | Water |
| | | Acetate | | | |
| AKD | Starch/PVA | Cellulose | Starch/PVA | | Water |
| | | Acetate | | | |
| AKD | Gelatin/PVA | Cellulose | Gelatin/PVA | | Water |
| | | Acetate | | | |
| Starch | Starch/ | Cellulose | Starch | Glycerol | Water |
| | Cellulose | Acetate | | | |
| Gelatin | Gelatin/PVA | Cellulose | Gelatin/PVA | | Water |
| | | Acetate | | | |

Table 2 provides further examples of the composites of the present disclosure. The composites are used as a material either alone or in combination with a biopolymer and/or pulp to form a containment.

TABLE 2

| Binding | | Structural | | | |
|---|---|---|---|---|---|
| Agent | Active Agent | Agent | Gelatinizer | Plasticizer | Solvent Scheme |
| Gelatin | Corn | Cellulose | Corn | | |
| | Starch/Gelatin | Acetate | Starch/Gelatin | | |
| Gelatin | Corn | Sodium | Corn | | WATER- |
| | Starch/Gelatin | Acetate | Starch/Gelatin | | CHLOROFORM- |
| | | | | | ACETONE- |
| | | | | | ETHANOL- |
| | | | | | TOLUENE |
| Gelatin | Cassava | Cellulose | Cassava | | WATER- |
| | starch/Gelatin | Acetate | starch/Gelatin | | CHLOROFORM- |
| | | | | | ACETONE- |
| | | | | | ETHANOL- |
| | | | | | TOLUENE |
| Gelatin | Cassava | Sodium | Cassava | | WATER- |
| | starch/Gelatin | Acetate | starch/Gelatin | | CHLOROFORM- |
| | | | | | ACETONE- |
| | | | | | ETHANOL- |
| | | | | | TOLUENE |
| Gelatin | Yam starch/ | Cellulose | Yam starch/ | | WATER- |
| | Gelatin | Acetate | Gelatin | | CHLOROFORM- |
| | | | | | ACETONE- |
| | | | | | ETHANOL- |
| | | | | | TOLUENE |
| Gelatin | Yam starch/ | Sodium | Yam starch/ | | WATER- |
| | Gelatin | Acetate | Gelatin | | CHLOROFORM- |
| | | | | | ACETONE- |
| | | | | | ETHANOL- |
| | | | | | TOLUENE |
| | Agar | Cellulose | Agar | Glycerol | WATER- |
| | | Acetate | | | CHLOROFORM- |
| | | | | | ACETONE- |
| | | | | | ETHANOL- |
| | | | | | TOLUENE |
| | Agar | Sodium | Agar | Glycerol | WATER- |
| | | Acetate | | | CHLOROFORM- |
| | | | | | ACETONE- |
| | | | | | ETHANOL- |
| | | | | | TOLUENE |
| Gelatin | Corn | Cellulose | Corn | Glycerol | WATER- |
| | Starch/Gelatin | Acetate | Starch/Gelatin | | CHLOROFORM- |
| | | | | | ACETONE- |
| | | | | | ETHANOL- |
| | | | | | TOLUENE |
| Gelatin | Corn | Sodium | Corn | Glycerol | WATER- |
| | Starch/Gelatin | Acetate | Starch/Gelatin | | CHLOROFORM- |
| | | | | | ACETONE- |
| | | | | | ETHANOL- |
| | | | | | TOLUENE |
| Carboxy | Corn | Cellulose | Corn starch | Glycerol | WATER- |
| Methyl | Starch/Carboxy | Acetate | | | CHLOROFORM- |
| Cellulose | Methyl | | | | ACETONE- |
| | Cellulose | | | | ETHANOL- |
| | | | | | TOLUENE |
| Carboxy | Corn | Sodium | Corn starch | Glycerol | WATER- |
| Methyl | Starch/Carboxy | Acetate | | | CHLOROFORM- |
| Cellulose | Methyl | | | | ACETONE- |
| | Cellulose | | | | ETHANOL- |
| | | | | | TOLUENE |
| Gelatin | Cassava | Cellulose | Cassava | Glycerol | WATER- |
| | starch/Gelatin | Acetate | starch/Gelatin | | CHLOROFORM- |
| | | | | | ACETONE- |
| | | | | | ETHANOL- |
| | | | | | TOLUENE |
| Gelatin | Cassava | Sodium | Cassava | Glycerol | WATER- |
| | starch/Gelatin | Acetate | starch/Gelatin | | CHLOROFORM- |
| | | | | | ACETONE- |
| | | | | | ETHANOL- |
| | | | | | TOLUENE |
| Gelatin | Yam starch/ | Cellulose | Yam starch/ | Glycerol | WATER- |
| | Gelatin | Acetate | Gelatin | | CHLOROFORM- |
| | | | | | ACETONE- |
| | | | | | ETHANOL- |
| | | | | | TOLUENE |
| Gelatin | Yam starch/ | Sodium | Yam starch/ | Glycerol | WATER- |
| | Gelatin | Acetate | Gelatin | | CHLOROFORM- |
| | | | | | ACETONE- |
| | | | | | ETHANOL- |
| | | | | | TOLUENE |
| Gelatin | Lignin | Cellulose | Gelatin | Glycerol | WATER |
| | | Acetate | | | |
| Gelatin | Lignin | Sodium | Gelatin | Glycerol | WATER |
| | | Acetate | | | |
| Corn starch | Corn starch/ | Cellulose | corn starch | Sorbitol | WATER |
| | lignin | Acetate | | | |
| Corn starch | Corn | Sodium | corn starch | Sorbitol | WATER |
| | starch/lignin | Acetate | | | |
| Corn starch | Corn | Cellulose | Corn starch | Glycerol/ | WATER |
| | starch/Lignin | Acetate | | sorbitol | |
| Corn starch | Corn | Sodium | Corn starch | Glycerol/ | WATER |
| | starch/Lignin | Acetate | | sorbitol | |
| Cassava | Cassava | Cellulose | Cassava | Sorbitol | WATER |
| starch | starch/Lignin | Acetate | starch | | |
| Cassava | Cassava | Sodium | Cassava | Sorbitol | WATER |
| starch | starch/Lignin | Acetate | starch | | |
| Yam starch | Yam starch/ | Cellulose | yam starch | Sorbitol | WATER |
| | Lignin | Acetate | | | |
| Yam starch | Yam starch/ | Sodium | Yam starch | Sorbitol | WATER |
| | Lignin | Acetate | | | |
| Gelatin | Palm sago | Cellulose | Palm sago | | WATER- |
| | starch/Gelatin | Acetate | starch/ | | CHLOROFORM- |
| | | | Gelatin | | ACETONE- |
| | | | | | ETHANOL- |
| | | | | | TOLUENE |
| Gelatin | Palm sago | Sodium | Palm sago | | WATER- |
| | starch/Gelatin | Acetate | starch/ | | CHLOROFORM- |
| | | | Gelatin | | ACETONE- |
| | | | | | ETHANOL- |
| | | | | | TOLUENE |
| Gelatin | Palm sago | Cellulose | Palm sago | Glycerol | WATER- |
| | starch/Gelatin | Acetate | starch/ | | CHLOROFORM- |
| | | | Gelatin | | ACETONE- |
| | | | | | ETHANOL- |
| | | | | | TOLUENE |
| Gelatin | Palm sago | Sodium | Palm sago | Glycerol | WATER- |
| | starch/Gelatin | Acetate | starch/ | | CHLOROFORM- |
| | | | Gelatin | | ACETONE- |
| | | | | | ETHANOL- |
| | | | | | TOLUENE |
| Carboxy | Palm sago | Cellulose | Palm sago | Glycerol | WATER- |
| Methyl | starch | Acetate | starch | | CHLOROFORM- |
| Cellulose | | | | | ACETONE- |
| | | | | | ETHANOL- |
| | | | | | TOLUENE |
| Carboxy | Palm sago | Sodium | Palm sago | Glycerol | WATER- |
| Methyl | starch | Acetate | starch | | CHLOROFORM- |
| Cellulose | | | | | ACETONE- |
| | | | | | ETHANOL- |
| | | | | | TOLUENE |
| Palm sago | Palm sago | Cellulose | Palm sago | Glycerol | WATER |
| starch | starch/Lignin | Acetate | starch | | |
| Palm sago | Palm sago | Sodium acetate | Palm sago | Glycerol/ | WATER |
| starch | starch/Lignin | | starch | sorbitol | |
| Palm sago | Palm sago | Cellulose | | | WATER |
| starch | starch/Lignin | Acetate | | | |
| Palm sago | Palm sago | Sodium acetate | Palm sago | Sorbitol | WATER |
| starch | starch/Lignin | | starch | | |
| Corn starch | Corn | Cellulose | Corn starch | Glycerol | WATER |
| | starch/Polyvinyl | Acetate | | | |
| | Alcohol (PVA) | | | | |
| Cassava | Cassava starch/ | Sodium acetate | Cassava | Glycerol | WATER |
| starch | Polyvinyl | | starch | | |
| | Alcohol (PVA) | | | | |
| Yam starch | Yam | Cellulose | Yam starch | Glycerol | WATER |
| | starch/Polyvinyl | Acetate | | | |
| | Alcohol (PVA) | | | | |
| Palm sago | Palm sago | Sodium acetate | Palm sago | Glycerol | WATER |
| starch | starch/PVA | | starch | | |
| Corn starch | Corn | Cellulose | Corn starch | Glycerol | WATER- |
| | starch/Polyvinyl | Acetate | | | CHLOROFORM- |
| | alcohol | | | | ACETONE- |
| | | | | | ETHANOL- |
| | | | | | TOLUENE |
| Corn starch | Corn | Sodium acetate | Corn starch | Glycerol | WATER- |
| | starch/Polyvinyl | | | | CHLOROFORM- |
| | alcohol | | | | ACETONE- |
| | | | | | ETHANOL- |
| | | | | | TOLUENE |
| Cassava | Cassava starch/ | Cellulose | Cassava | Glycerol | WATER- |
| starch | PVA | acetate | starch | | CHLOROFORM- |
| | | | | | ACETONE- |
| | | | | | ETHANOL- |
| | | | | | TOLUENE |
| Cassava | Cassava starch/ | Sodium acetate | Cassava | Glycerol | WATER- |
| starch | PVA | | starch | | CHLOROFORM- |
| | | | | | ACETONE- |
| | | | | | ETHANOL- |
| | | | | | TOLUENE |
| Yam starch | Yam | Cellulose | Yam starch | Glycerol | WATER- |
| | starch/PVA | acetate | | | CHLOROFORM- |
| | | | | | ACETONE- |
| | | | | | ETHANOL- |
| | | | | | TOLUENE |
| Yam starch | Yam | Sodium acetate | Yam starch | Glycerol | WATER- |
| | starch/PVA | | | | CHLOROFORM- |
| | | | | | ACETONE/ |
| | | | | | ETHANOL |
| | | | | | TOLUENE |
| Palm sago | palm sago | Cellulose | Palm sago | Glycerol | WATER- |
| starch | starch/PVA | acetate | starch | | CHLOROFORM- |
| | | | | | ACETONE- |
| | | | | | ETHANOL- |
| | | | | | TOLUENE |
| Palm sago | palm sago | sodium acetate | Palm sago | Glycerol | WATER- |
| starch | starch/PVA | | starch | | CHLOROFORM- |
| | | | | | ACETONE- |
| | | | | | ETHANOL- |
| | | | | | TOLUENE |
| Gelatin | Gelatin/PVA | Cellulose | Gelatin | Glycerol | WATER- |
| | | acetate/Sodium | | | CHLOROFORM- |
| | | acetate | | | ACETONE- |
| | | | | | ETHANOL- |
| | | | | | TOLUENE |
| Gelatin | Gelatin/PVA | Cellulose | Gelatin | Glycerol | WATER- |
| | | acetate | | | CHLOROFORM- |
| | | | | | ACETONE- |
| | | | | | ETHANOL- |
| | | | | | TOLUENE |
| Gelatin | Gelatin/PVA | Sodium acetate | Gelatin | Glycerol | WATER- |
| | | | | | CHLOROFORM- |
| | | | | | ACETONE- |
| | | | | | ETHANOL- |
| | | | | | TOLUENE |
| AKD | Corn | Cellulose | Corn starch | | WATER |
| | starch/PVA | acetate | | | |
| AKD | Cassava starch/ | Sodium acetate | Cassava | | WATER |
| | PVA | | starch | | |
| AKD | Yam | Cellulose | Yam starch | | WATER |
| | starch/PVA | acetate | | | |
| AKD | Palm sago | Sodium acetate | Palm sago | | WATER |
| | starch/PVA | | starch | | |
| AKD | Corn | Cellulose | Corn starch | | WATER- |
| | starch/PVA | acetate | | | CHLOROFORM- |
| | | | | | ACETONE- |
| | | | | | ETHANOL- |
| | | | | | TOLUENE |
| AKD | Corn | Sodium acetate | Corn starch | | WATER- |
| | starch/PVA | | | | CHLOROFORM- |
| | | | | | ACETONE- |
| | | | | | ETHANOL- |
| | | | | | TOLUENE |
| AKD | Cassava starch/ | Cellulose | Cassava | | WATER- |
| | PVA | acetate | starch | | CHLOROFORM- |
| | | | | | ACETONE- |
| | | | | | ETHANOL- |
| | | | | | TOLUENE |
| Cassava | Cassava starch/ | Sodium acetate | Cassava | Glycerol | WATER- |
| starch | PVA | | starch | | CHLOROFORM- |
| | | | | | ACETONE- |
| | | | | | ETHANOL- |
| | | | | | TOLUENE |
| Yam starch | Yam | Cellulose | Yam starch | Glycerol | WATER- |
| | starch/PVA | acetate | | | CHLOROFORM- |
| | | | | | ACETONE- |
| | | | | | ETHANOL- |
| | | | | | TOLUENE |
| Yam starch | Yam | Sodium acetate | Yam starch | Glycerol | WATER- |
| | starch/PVA | | | | CHLOROFORM- |
| | | | | | ACETONE- |
| | | | | | ETHANOL- |
| | | | | | TOLUENE |
| Palm sago | palm sago | Cellulose | Palm sago | Glycerol | WATER- |
| starch | starch/PVA | acetate | starch | | CHLOROFORM- |
| | | | | | ACETONE- |
| | | | | | ETHANOL- |
| | | | | | TOLUENE |
| Palm sago | palm sago | Sodium acetate | Palm sago | Glycerol | WATER- |
| starch | starch/PVA | | starch | | CHLOROFORM- |
| | | | | | ACETONE- |
| | | | | | ETHANOL- |
| | | | | | TOLUENE |
| AKD | Corn starch/ | Cellulose | Corn starch/ | | WATER |
| | Gelatin/PVA | acetate | Gelatin | | |
| AKD | Cassava starch/ | Sodium acetate | Cassava/ | | WATER |
| | Gelatin/PVA | | Gelatin | | |
| AKD | Yam/Gelatin/ | Cellulose | Yam/Gelatin | | WATER |
| | PVA | acetate | | | |
| AKD | Palm sago | Sodium acetate | Palm sago | | WATER |
| | starch/ | | starch/ | | |
| | Gelatin/PVA | | Gelatin | | |
| AKD | Corn starch/ | Cellulose | Corn starch/ | | WATER- |
| | Gelatin/PVA | acetate | gelatin | | CHLOROFORM- |
| | | | | | ACETONE- |
| | | | | | ETHANOL- |
| | | | | | TOLUENE |
| AKD | Corn starch/ | Sodium acetate | Corn starch/ | | WATER- |
| | Gelatin/PVA | | gelatin | | CHLOROFORM- |
| | | | | | ACETONE- |
| | | | | | ETHANOL- |
| | | | | | TOLUENE |
| AKD | Cassava starch/ | Cellulose | cassava | | WATER- |
| | Gelatin/PVA | acetate | starch/gelatin | | CHLOROFORM- |
| | | | | | ACETONE- |
| | | | | | ETHANOL- |
| | | | | | TOLUENE |
| Gelatin | Cassava starch/ | Sodium acetate | cassava | Glycerol | WATER- |
| | Gelatin/PVA | | starch/gelatin | | CHLOROFORM- |
| | | | | | ACETONE- |
| | | | | | ETHANOL- |
| | | | | | TOLUENE |
| Gelatin | Yam starch/ | Cellulose | yam | Glycerol | WATER- |
| | Gelatin/PVA | acetate | starch/gelatin | | CHLOROFORM- |
| | | | | | ACETONE- |
| | | | | | ETHANOL- |
| | | | | | TOLUENE |
| Gelatin | Yam starch/ | Sodium acetate | yam | Glycerol | WATER- |
| | Gelatin/PVA | | starch/gelatin | | CHLOROFORM- |
| | | | | | ACETONE- |
| | | | | | ETHANOL- |
| | | | | | TOLUENE |
| Gelatin | Palm sago | Cellulose | Palm sago | Glycerol | WATER- |
| | starch/ | acetate | starch/ | | CHLOROFORM- |
| | Gelatin/PVA | | Gelatin | | ACETONE- |
| | | | | | ETHANOL- |
| | | | | | TOLUENE |
| Gelatin | Palm sago | Sodium acetate | Palm sago | Glycerol | WATER- |
| | starch/ | | starch/ | | CHLOROFORM- |
| | Gelatin/PVA | | Gelatin | | ACETONE- |
| | | | | | ETHANOL- |
| | | | | | TOLUENE |
| Gelatin | PVA | | Gelatin | Glycerol | WATER |
| Starch | PVA | | Starch | Glycerol | WATER |
| Gelatin | PVA | AKD | Gelatin | Glycerol | WATER |
| Starch | PVA | AKD | Starch | Glycerol | WATER |
| AKD | PVA | AKD | TEOS | | WATER |
| Bees Wax | PVA | AKD | TEOS | | WATER |
| AKD | PVA | AKD | TEOS | | ETHANOL |
| Bees Wax | PVA | AKD | TEOS | | ETHANOL |
| Corn Starch | Gelatin | | Gelatin | Glycerol | WATER |
| Tapioca | Gelatin | | Gelatin | Glycerol | WATER |
| Palm Starch | Gelatin | | Gelatin | Glycerol | WATER |
| Corn Starch | Gelatin | | Gelatin | Glycerol | ETHANOL |
| Tapioca | Gelatin | | Gelatin | Glycerol | ETHANOL |
| Palm root | Gelatin | | Gelatin | Glycerol | ETHANOL |
| Corn Starch | Gelatin | | Gelatin | Glycerol | WATER- |
| | | | | | ETHANOL |

Various modifications of the present disclosure, in addition to those shown and described herein, will be apparent to those skilled in the art of the above description. Such modifications are also intended to fall within the scope of the appended claims.

It is appreciated that all reagents are obtainable by sources known in the art unless otherwise specified.

It is also to be understood that this disclosure is not limited to the specific aspects and methods described herein, as specific components and/or conditions may, of course, vary. Furthermore, the terminology used herein is used only for the purpose of describing particular aspects of the present disclosure and is not intended to be limiting in any way. It will be also understood that, although the terms “first,” “second,” “third” etc. may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, “a first element,” “component,” “region,” “layer,” or “section” discussed below could be termed a second (or other) element, component, region, layer, or section without departing from the teachings herein. Similarly, as used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. The term “or a combination thereof” means a combination including at least one of the foregoing elements.

Unless otherwise defined, all terms (including technical and scientific terms) used herein have the same meaning as commonly understood by one of ordinary skill in the art to which this disclosure belongs. It will be further understood that terms such as those defined in commonly used dictionaries, should be interpreted as having a meaning that is consistent with their meaning in the context of the relevant art and the present disclosure, and will not be interpreted in an idealized or overly formal sense unless expressly so defined herein.

Reference is made in detail to exemplary compositions, aspects and methods of the present disclosure, which constitute the best modes of practicing the disclosure presently known to the inventors. The drawings are not necessarily to scale. However, it is to be understood that the disclosed aspects are merely exemplary of the disclosure that may be embodied in various and alternative forms. Therefore, specific details disclosed herein are not to be interpreted as limiting, but merely as a representative basis for any aspect of the disclosure and/or as a representative basis for teaching one skilled in the art to variously employ the present disclosure.

Patents, publications, and applications mentioned in the specification are indicative of the levels of those skilled in the art to which the disclosure pertains. These patents, publications, and applications are incorporated herein by reference to the same extent as if each individual patent, publication, or application was specifically and individually incorporated herein by reference.

The foregoing description is illustrative of particular embodiments of the disclosure, but is not meant to be a limitation upon the practice thereof. The following claims, including all equivalents thereof, are intended to define the scope of the disclosure.

1. A containment comprised of a biopolymer layer comprised of a biopolymer, wherein the biopolymer includes at least one of polyhydroxyalkanote (PHA), poly(hydroxybutyrate-co-hydroxy valerate (PHBV), polybutylene succinate (PBS), lignin, starch, polyhydroxybutyrate (PHB), PHBH (random copolymer of (R)-3-hydroxybutyrate and (R)-3-hydroxyhexanoate), polylactic acid (PLA), polybutylene adipate terephthalate (PBAT), PBST (polybutylene succinate-co-terephthalate), PBSA (polybutylene succinate-co-butylene adipate), polybutylene terephthalate (PBT), poly(vinyl) alcohol (PVA), poly(glycolic acid) (PGA), chitosan, polycaprolactone (PCL), and combinations thereof.

2. The containment of claim 1, wherein the biopolymer is a composite of one or more polymeric compounds and a material.

3. The containment of claim 2, wherein in the material comprises at least one of silica nanoparticles, hydrophobic silica nanoparticles, bees wax, soya wax, cellulose, cellulose acetate, cellulose triacetate, carboxy methyl cellulose, alkyl ketene dimer (AKD), AKD nanoparticles, AKD wax, poly(vinyl) alcohol (PVA), palmityl chloride, polyvinyl palmitate chloride (PVPC), starch (soluble), starch nanoparticles, xylan, tapioca, palm root, tetraethyl orthosilicate (TEOS), zein, zein nanoparticles, glycerol, gelatin, sorbitol, ammonium zirconium carbonate (AZC), ethylene-vinyl alcohol copolymer (EVOH), polyhydroxy alkanotes (PHA), polydimethylsiloxane (PDMS), gelatin, sodium acetate, lignin, zinc oxide nanoparticles, copper (II) oxide nanoparticles, copper (I) oxide nanoparticles, magnesium oxide nanoparticles, nano clay nanoparticles, nano-starch nanoparticles, beeswax nanoparticles, soy wax nanoparticles, nano-cellulose nanoparticles, carbon nanotubes nanoparticles, carbon nanotube fiber nanoparticles, stearic acid, glycerol, starch, HNTs, PDMS, soybean oil, zein, chitosan, nano clay, cellulose nanofibers, cellulose ester(s), PLA, and/or PCL and/or titanium dioxide nanoparticles.

4. The containment according to claim 1, wherein the biopolymer layer is heat sealed.

5. The containment according to claim 1, further comprising a material layer.

6. The containment according to claim 5, wherein the material layer comprises a composite of at least two of a binding agent, an active agent, a structural agent, a plasticizer, and a gelatinizer.

7. The containment of claim 6, wherein the binding agent is selected from natural waxes, bees wax, soya wax, alkyl ketone dimer (AKD), starch (e.g. maize starch, yam starch, corn starch, palm starch, and cassava starch), ethylene vinyl alcohol (EVOH), polydimethylsiloxane (PDMS), gelatin, tapioca, palm root, cellulose, carboy methyl cellulose, and combinations thereof.

8. The containment of claim 7, wherein the active agent is selected from gelatin, polyvinyl alcohol (PVA), starch (e.g. yam starch, palm starch (or palm sago starch), cassava starch, maize starch, and corn starch), AKD nanoparticles, silica nanoparticles, hydrophobic silica nanoparticles, EVOH, zein nanoparticles, cellulose, starch nanoparticles, agar, carboxy methyl cellulose, lignin, and combinations thereof.

9. The containment of claim 7, wherein the structural agent is selected from cellulose acetate, cellulose triaceteate, palmityl chloride, sodium acetate, or combinations thereof.

10. The containment of claim 7, wherein the plasticizer is selected from glycerol, xylene, sorbitol, glycerol and sorbitol, and combinations thereof.

11. The containment of claim 7, wherein the gelatinizer is selected from starch; gelatin; starch and gelatin, TEOS, agar, PVA, PVA and gelatin, polydimethylsiloxane (PDMS), EVOH, stearic acid, polyvinyl palmitate chloride, polyhydroxy alkanotes (PHA), PVA, PVPC, PVA and PVPC, cellulose, ammonium zirconium carbonate (AZC), and combinations thereof.

12. The containment according to claim 1, further comprising a pulp layer.

13. A containment comprised of a material comprised of a composite of at least two of a binding agent, an active agent, a structural agent, a gelatinizer, and a plasticizer.

14. The containment of claim 13, wherein the binding agent is selected from natural waxes, bees wax, soya wax, alkyl ketone dimer (AKD), starch (e.g. maize starch, yam starch, corn starch, palm starch, and cassava starch), ethylene vinyl alcohol (EVOH), polydimethylsiloxane (PDMS), gelatin, cellulose, tapioca, palm root, carboy methyl cellulose, and combinations thereof.

15. The containment of claim 13, wherein the active agent is selected from gelatin, polyvinyl alcohol (PVA), starch (e.g. yam starch, palm starch (or palm sago starch), cassava starch, maize starch, and corn starch), AKD nanoparticles, silica nanoparticles, hydrophobic silica nanoparticles, EVOH, zein nanoparticles, cellulose, starch nanoparticles, agar, carboxy methyl cellulose, lignin, and combinations thereof.

16. The containment of claim 13, wherein the structural agent is selected from cellulose acetate, cellulose triaceteate, palmityl chloride, sodium acetate, or combinations thereof.

17. The containment of claim 13, wherein the plasticizer is selected from glycerol, xylene, sorbitol, glycerol and sorbitol, and combinations thereof.

18. The containment of claim 13, wherein the gelatinizer is selected from starch; gelatin; starch and gelatin; agar; PVA, TEOS, PVA and gelatin, polydimethylsiloxane (PDMS), EVOH, stearic acid, polyvinyl palmitate chloride, polyhydroxy alkanotes (PHA), PVA, PVPC, PVA and PVPC, cellulose, ammonium zirconium carbonate (AZC), and combinations thereof.

19. (canceled)

20. (canceled)

21. (canceled)

22. The containment according to claim 13, further comprising a biopolymer, wherein the biopolymer includes at least one of polyhydroxyalkanote (PHA), poly(hydroxybutyrate-co-hydroxy valerate (PHBV), polybutylene succinate (PBS), lignin, starch, polyhydroxybutyrate (PHB), PHBH (random copolymer of (R)-3-hydroxybutyrate and (R)-3-hydroxyhexanoate), polylactic acid (PLA), polybutylene adipate terephthalate (PBAT), PBST (polybutylene succinate-co-terephthalate), PBSA (polybutylene succinate-co-butylene adipate), polybutylene terephthalate (PBT), poly(vinyl) alcohol (PVA), poly(glycolic acid) (PGA), chitosan, polycaprolactone (PCL), and combinations thereof.

23. (canceled)
